(19) United States
(12) Patent Application Publication
(10) Pub. No.: US 2026/0003374 A1
(43) Pub. Date: Jan. 1, 2026

(54) VEHICLE CONTROL SYSTEM AND METHOD BASED ON AIR FLOW RATE

(71) Applicants: Hyundai Motor Company, Seoul (KR); Kia Corporation, Seoul (KR)

(72) Inventors: Jae Kwon LEE, Hwaseong-si (KR); Dae Ki HONG, Hwaseong-si (KR); Ki Hoon KIM, Hwaseong-si (KR); Jae Woong KIM, Hwaseong-si (KR); Se Kyu OH, Hwaseong-si (KR)

(73) Assignees: Hyundai Motor Company, Seoul (KR); Kia Corporation, Seoul (KR)

(21) Appl. No.: 18/938,521

(22) Filed: Nov. 6, 2024

(30) Foreign Application Priority Data
Jul. 1, 2024 (KR) 10-2024-0086251

(51) Int. Cl. G05D 7/06

(52) U.S. Cl. CPC G05D 7/0623

(57) ABSTRACT

A vehicle control system and method based on an air flow rate, control introduction of outside air based on an estimated driving current value of a blowing device, obtained through a current model preset based on a calm wind state, and an estimated air flow rate value of an inlet, obtained through an air flow rate model preset based on an outside wind state.

### CROSS-REFERENCE TO RELATED APPLICATION

The present application claims priority to Korean Patent Application No. 10-2024-0086251, filed on Jul. 1, 2024, the entire contents of which is incorporated herein for all purposes by this reference.

### BACKGROUND OF THE PRESENT DISCLOSURE

### Field of the Present Disclosure

The present disclosure relates to a control system and method for controlling a vehicle based on an air flow rate obtained through an estimation model.

### Description of Related Art

Recently, as interest in the environment increases, eco-friendly vehicles having an electric motor as a power source are on the rise. Such an eco-friendly vehicle is also referred to as an electrified vehicle, and representative examples thereof may include a hybrid electric vehicle (HEV) and an electric vehicle (EV). The present electrified vehicle consumes electrical energy not only for driving but also for indoor air conditioning. Thus, the efficiency of indoor air conditioning has a great influence on overall energy efficiency of an electrified vehicle having the driving power efficiency thereof.

Among electrified vehicles, an electric vehicle, which is not provided with an engine and travels only using driving force from a motor, is not capable of utilizing waste heat recovered from an engine for indoor air conditioning, and thus requires higher energy efficiency.

Furthermore, electrified vehicles are provided with components for driving, such as a high-voltage battery and a motor. Because the operation performance of these components is affected by temperature, there is an increasing need to consider requirements for the components as well as indoor air conditioning in terms of thermal management.

A thermal management system of a vehicle performs air conditioning for components of the vehicle and an indoor space in the vehicle using outside air introduced into the vehicle. As the number of considerations to be made in thermal management increases and accordingly control conditions diversify, there is an increasing need to accurately determine the flow rate of the outside air to achieve optimal thermal management.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle control system and method configured for optimally controlling a vehicle under various outside air conditions based on an air flow rate obtained through an estimation model.

The objects to be accomplished by the present disclosure are not limited to the above-mentioned objects, and other objects not mentioned herein will be clearly understood by those skilled in the art from the following description.

In accordance with an aspect of the present disclosure, the above and other objects may be accomplished by the provision of a system for controlling a vehicle based on an air flow rate, the system including a fluid transfer device, including an inlet receiving an outside air introduced thereinto from the outside of the vehicle and a blowing device configured to adjust the flow rate of the outside air introduced into the inlet, and a controller operatively connected to the fluid transfer device and configured to control introduction of the outside air through the fluid transfer device based on an estimated driving current value of the blowing device, obtained through a current model preset based on a calm wind state in which an outside wind speed is less than or equal to a predetermined reference wind speed, and an estimated air flow rate value of the inlet, obtained through an air flow rate model preset based on an outside wind state in which the outside wind speed exceeds the predetermined reference wind speed.

In accordance with another aspect of the present disclosure, there is provided a method of controlling, based on an air flow rate, a vehicle including a fluid transfer device including an inlet receiving an outside air introduced thereinto from the outside of the vehicle and a blowing device configured to adjust the flow rate of the outside air introduced into the inlet, the method including obtaining an estimated driving current value of the blowing device through a current model preset based on a calm wind state in which an outside wind speed is less than or equal to a predetermined reference wind speed, obtaining an estimated air flow rate value of the inlet through an air flow rate model preset based on an outside wind state in which the outside wind speed exceeds the predetermined reference wind speed, and controlling introduction of the outside air through the fluid transfer device based on the estimated driving current value of the blowing device and the estimated air flow rate value of the inlet.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram showing the configuration of a vehicle control system according to an exemplary embodiment of the present disclosure;

FIG. 2 is a diagram showing an implementation example of a fluid transfer device applicable to various exemplary embodiments of the present disclosure;

FIG. 3 is a diagram for explaining the configuration and operation of a controller according to an exemplary embodiment of the present disclosure;

FIG. 4 is a diagram for explaining an outside wind model according to an exemplary embodiment of the present disclosure; and

FIG. 5 is a flowchart for explaining a vehicle control method according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Specific structural and functional descriptions of the exemplary embodiments of the present disclosure included in the present specification or application are merely illustrative for explaining the exemplary embodiments according to an exemplary embodiment of the present disclosure, and the exemplary embodiments of the present disclosure may be implemented in various forms and should not be construed as being limited to the exemplary embodiments described in the present specification or application.

Since the exemplary embodiments of the present disclosure may be modified in various manners and have various forms, specific embodiments will be illustrated in the drawings and described in detail in the present specification or application. However, this is not intended to limit the exemplary embodiments according to the concept of the present disclosure to a specific disclosed form, and should be understood to include all modifications, equivalents, and substitutes included in the spirit and technical scope of the present disclosure.

Unless otherwise defined, all terms used herein, which include technical or scientific terms, include the same meanings as those generally appreciated by those skilled in the art. The terms, such as ones defined in common dictionaries, should be interpreted as having the same meanings as terms in the context of pertinent technology, and should not be interpreted as having ideal or excessively formal meanings unless clearly defined in the specification.

Hereinafter, the embodiments included in the present specification will be described in detail with reference to the accompanying drawings, and the same or similar constituent elements are denoted by the same reference numerals even though they are depicted in different drawings, and redundant descriptions thereof will be omitted.

In the description of the following embodiments, the term “preset” or “predetermined” means that, in a case in which a parameter is used in a process or an algorithm, the value of the parameter is set or determined in advance. Depending on embodiments, the value of a parameter may be set when a process or an algorithm starts or may be set during a period in which the process or the algorithm is performed.

The suffixes “module” and “unit” for constituent elements used in the following description are provided or used interchangeably only for ease of description of the specification, and do not have mutually distinguished meanings or roles in themselves.

In the following description of the exemplary embodiments included in the present specification, a detailed description of known functions and configurations incorporated herein will be omitted when the same may make the subject matter of the exemplary embodiments included in the present specification rather unclear. Furthermore, the accompanying drawings are provided only for a better understanding of the exemplary embodiments included in the present specification and are not intended to limit the technical ideas included in the present specification. Therefore, it should be understood that the accompanying drawings include all modifications, equivalents, and substitutes within the spirit and scope of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to the other component, or intervening components may be present. On the other hand, when a component is referred to as being “directly connected to” or “directly coupled to” another component, there are no intervening components present.

As used herein, the singular forms “a”, “an”, and “the” are intended to include the plural forms as well, unless the context clearly indicates otherwise.

It will be further understood that the terms “comprise”, “include”, and “have”, when used herein, specify the presence of stated features, integers, steps, operations, elements, components, or combinations thereof, but do not preclude the presence or addition of one or more other features, integers, steps, operations, elements, components, or combinations thereof.

To control the function peculiar thereto, a controller or a control unit may include a communication device, which communicates with other controllers or sensors, a memory, which stores therein an operating system, logic commands, and input/output information, and one or more processors, which perform determinations, calculations, and decisions necessary for control of the function peculiar thereto.

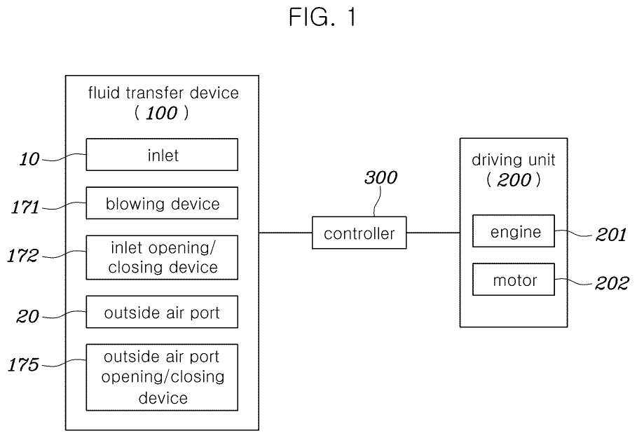

Hereinafter, the configuration of a vehicle control system according to an exemplary embodiment of the present disclosure will be described with reference to FIG. 1.

FIG. 1 is a diagram showing the configuration of a vehicle control system according to an exemplary embodiment of the present disclosure.

Referring to FIG. 1, the vehicle control system according to the exemplary embodiment of the present disclosure may include a fluid transfer device 100, a driving unit 200, and a controller 300.

The fluid transfer device 100 may include an inlet 10 into which outside air is introduced from the outside of the vehicle, a blowing device 171 configured to adjust the flow rate of the outside air introduced into the inlet 10, an inlet opening/closing device 172 configured to adjust the degree of opening of the inlet 10, an outside air port 20 through which the outside air is introduced into an indoor space in the vehicle, and an outside air port opening/closing device 175 configured to adjust the degree of opening of the outside air port 20.

In the instant case, the inlet 10 may be provided, for example, under the hood of the vehicle. The blowing device 171 may be a fan configured to be driven by a motor. The inlet opening/closing device 172 may be a flap or a door configured to rotate about an axis by an actuator such as a motor. The outside air port 20 may be provided, for example, in a side of the indoor space in the vehicle. The outside air port opening/closing device 175 to which the controller 300 is operatively connected may be implemented as a flap or a door configured to rotate about an axis by an actuator such as a motor, similar to the inlet opening/closing device 172, and may be configured to adjust not only the degree of opening of the outside air port 20 but also the degree of opening of an inside air port for circulation of inside air.

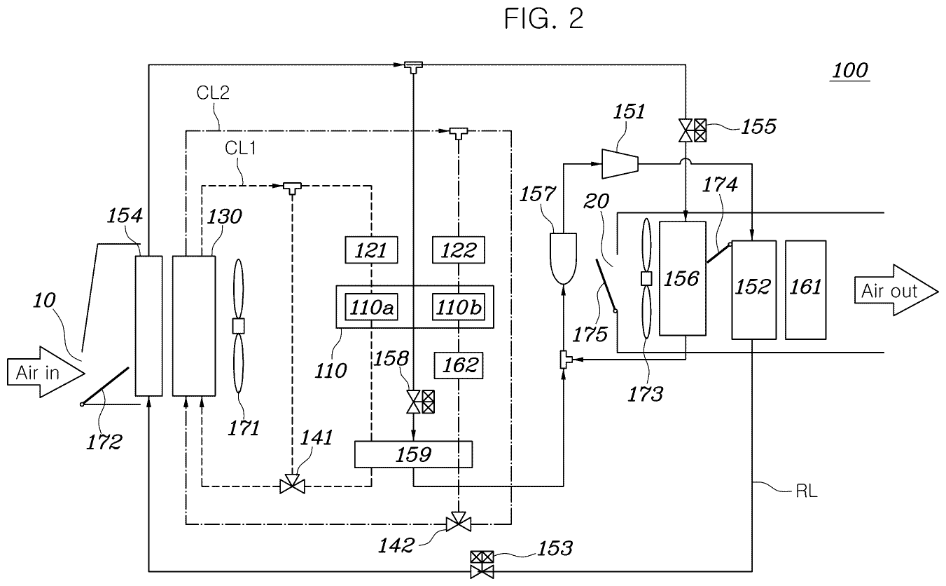

Although FIG. 1 illustrates only the components related to the description of the exemplary embodiment of the present disclosure, the fluid transfer device 100 may include a greater or smaller number of components than those illustrated in FIG. 1. A detailed description of the configuration of the fluid transfer device 100 will be provided with reference to FIG. 2.

The driving unit 200 may supply driving force to the vehicle through at least one of an engine 201 or a motor 202. For example, in a case in which the vehicle control system according to the exemplary embodiment of the present disclosure is implemented in an internal combustion engine vehicle, the driving unit 200 may include only the engine 201. In a case in which the vehicle control system according to the exemplary embodiment of the present disclosure is implemented in an electric vehicle, the driving unit 200 may include only the motor 202. In a case in which the vehicle control system according to the exemplary embodiment of the present disclosure is implemented in a hybrid vehicle, the driving unit 200 may include both the engine 201 and the motor 202.

The controller 300 may obtain an estimated driving current value of the blowing device 171 and an estimated air flow rate value of the inlet 10 through an estimation model, and may be configured for controlling introduction of the outside air through the fluid transfer device 100 based on the obtained estimated driving current value and the obtained estimated air flow rate value.

For example, to control introduction of the outside air, based on the obtained estimated driving current value and the obtained estimated air flow rate value, the controller 300 may be configured for controlling the operation amount of the blowing device 171 to which the controller 300 is operatively connected, may be configured for controlling the degree of opening of the inlet 10 through the inlet opening/closing device 172, and may be configured for controlling the degree of opening of the outside air port 20 through the outside air port opening/closing device 175 to which the controller 300 is operatively connected.

Furthermore, the controller 300 may be configured for controlling the driving force through the driving unit 200 to which the controller 300 is operatively connected, based on the obtained estimated driving current value and the obtained estimated air flow rate value. In the instant case, the controller 300 may be configured to determine air resistance for the vehicle based on the estimated air flow rate value. For example, the controller 300 may be configured to determine air resistance for the vehicle by considering the estimated air flow rate value along with a drag coefficient of the vehicle, air density, a cross-sectional area of the vehicle, and a speed of the vehicle. Then, the controller 300 may reduce or increase the driving force based on load caused by air resistance.

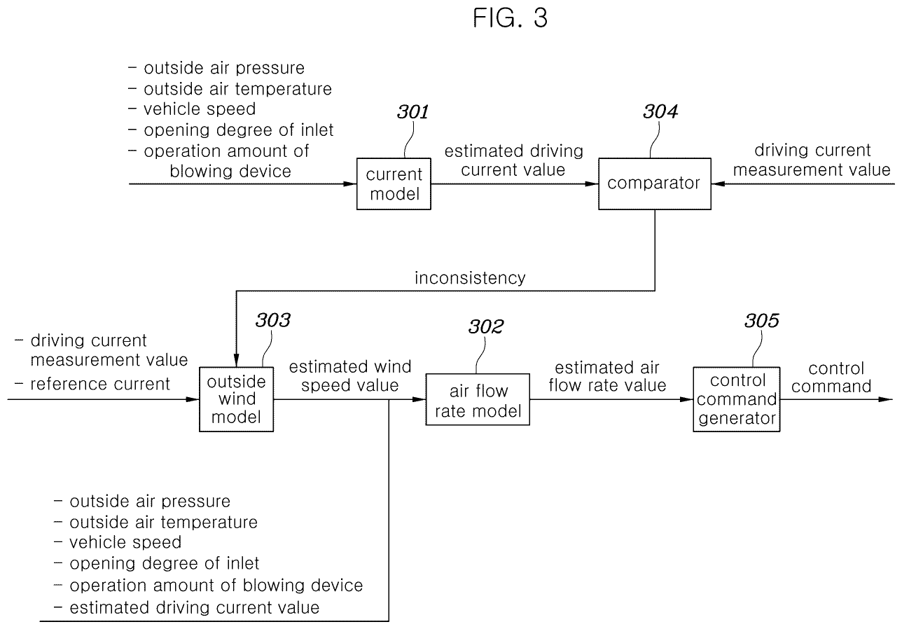

The detailed configuration and operation of the controller 300 will be described later with reference to FIG. 3.

Hereinafter, an implementation example of the fluid transfer device 100 will be described with reference to FIG. 2.

FIG. 2 is a diagram showing an implementation example of the fluid transfer device applicable to the exemplary embodiments of the present disclosure.

Referring to FIG. 2, the fluid transfer device 100 applicable to the exemplary embodiments of the present disclosure may perform vehicle thermal management, such as cooling or heating of at least one vehicle component 110 or cooling or heating of the indoor space (cabin) in the vehicle.

To the present end, the fluid transfer device 100 may be provided with coolant lines CL1 and CL2 configured to exchange heat with the vehicle component 110, and may also be provided with a refrigerant line RL configured to exchange heat with coolant and surrounding air.

In more detail, the fluid transfer device 100 may be provided with a plurality of coolant lines CL1 and CL2. To achieve thermal management of different vehicle components 110, each of the coolant lines CL1 and CL2 may individually exchange heat with a respective one of the vehicle components 110.

Here, the vehicle components 110 may include a driving system 110a, such as a motor or an inverter, and a battery 110b. However, in the exemplary embodiments of the present disclosure, the vehicle components 110 are not limited to those exemplified above, and may include various other components requiring heat dissipation. For example, the vehicle components 110 may include various types of control units, such as an autonomous driving control unit, a motor control unit, a vehicle control unit, and a control unit involved in performing integrated thermal management according to the exemplary embodiment of the present disclosure.

Although the coolant line CL1 for thermal management of the driving system 110a and the coolant line CL2 for thermal management of the battery 110b are shown in FIG. 2, the fluid transfer device 100 may be implemented so that the coolant lines CL1 and CL2 are replaced with or coexist with coolant lines for thermal management of other vehicle components 110 such as control units. Furthermore, implementation examples of the fluid transfer device 100 may include various cases, such as a case in which only a single coolant line for thermal management of one vehicle component 110 is provided or a case in which a plurality of vehicle components 110 is connected in series to a single coolant line.

Pumps 121 and 122 for circulation of the coolant may be respectively provided on the coolant lines CL1 and CL2. The pumps 121 and 122 may consume power to move the coolant to the vehicle components 110. Each of the pumps 121 and 122 may be implemented as, for example, an electric water pump (EWP) that drives a motor using electrical energy to circulate coolant and to which the controller 300 is operatively connected.

The coolant transferred to the vehicle components 110 through the pumps 121 and 122 may absorb heat generated by the vehicle components 110 through heat-exchange while passing through the vehicle components 110, cooling the vehicle components 110.

The coolant having passed through the vehicle components 110 may flow to a radiator 130, may dissipate the heat absorbed from the vehicle components 110 to the surroundings while passing through the radiator 130, and then may flow back to the vehicle components 110.

In the instant case, the radiator 130 may be individually provided on each of the coolant lines CL1 and CL2, and the radiator 130 corresponding to each of the coolant lines CL1 and CL2 may be divided into, for example, a high-temperature radiator and a low-temperature radiator.

A compressor 151, a plurality of condensers 152 and 154, a plurality of expanders 153, 155, and 158, an evaporator 156, an accumulator 157, and a heat absorber 159 may be provided on the refrigerant line RL.

Here, the compressor 151 may consume power to discharge refrigerant in a high-temperature and high-pressure state to function as a heat pump for circulation of the refrigerant. The refrigerant having passed through the compressor 151 repeatedly dissipates and absorbs heat to or from the surroundings while passing through the indoor condenser 152, the expander 153, the outdoor condenser 154, the expander 155, the evaporator 156, and the accumulator 157.

The refrigerant line RL may pass through the coolant lines CL1 and CL2 to recover waste heat of the vehicle components 110 from the coolant lines CL1 and CL2, and may exchange heat with the coolant lines CL1 and CL2 through the heat absorber 159 connected to the coolant lines CL1 and CL2. Unlike the configuration shown in FIG. 1, the fluid transfer device 100 may include a plurality of heat absorbers 159, each of which is connected to a respective one of the coolant lines CL1 and CL2.

To perform vehicle thermal management for different purposes, the fluid transfer device 100 may form various heat transfer paths through the coolant lines CL1 and CL2.

For example, the coolant line CL1 for thermal management of the driving system 110a may form a heat transfer path that dissipates heat absorbed from the driving system 110a to the outside through the radiator 130 and a heat transfer path that transfers heat absorbed from the driving system 110a to the refrigerant line RL through the heat absorber 159. These heat transfer paths may be formed simultaneously.

The above heat transfer paths may be varied depending on the flow direction of the coolant, and the flow direction of the coolant may be controlled by a valve 141 provided on the coolant line CL1. The valve 141 may include an actuator such as a motor, to which the controller 300 is operatively connected. Furthermore, to prevent heat generated by the driving system 110a from being dissipated through the radiator 130 or the heat absorber 159, circulation of the coolant may be suppressed by, for example, interrupting the operation of the pump 121.

In another example, the coolant line CL2 for thermal management of the battery 110b may form a heat transfer path that dissipates heat absorbed from the battery 110b to the outside through the radiator 130 and a heat transfer path that does not pass through the radiator 130. Depending on circulation of the refrigerant through the refrigerant line RL, the heat transfer path that does not pass through the radiator 130 may transfer heat generated by the battery 110b to the refrigerant line RL through the heat absorber 159 to cool the battery 110b, or may transfer heat of the coolant increased in temperature by a heater 162 heating the coolant to the battery 110b to increase the temperature of the battery 110b, rather than transferring the heat to the refrigerant line RL. The above heat transfer paths may be varied depending on the flow direction of the coolant, and the flow direction of the coolant may be controlled by a valve 142 provided on the coolant line CL2. The valve 142 may include an actuator such as a motor, to which the controller 300 is operatively connected.

The fluid transfer device 100 may recover heat generated by the vehicle components 110, i.e., waste heat, through the heat transfer path that transfers heat absorbed from the vehicle components 110 to the refrigerant line RL through the heat absorber 159, among the above heat transfer paths, and may recycle the recovered waste heat for indoor thermal management or the like, with a result that energy efficiency of vehicle thermal management may be improved.

Furthermore, the fluid transfer device 100 may also perform vehicle thermal management through heat-exchange with outside air. In performing such thermal management, the fluid transfer device 100 may be configured for controlling introduction of air into the indoor space from the outdoor space, and may include a blowing device and an opening/closing device for control of introduction of air.

The blowing device to which the controller 300 is operatively connected may include, for example, a cooling fan 171 for control of introduction of outside air and a blower 173 for control of discharge of air into the indoor space in the vehicle. The opening/closing device to which the controller 300 is operatively connected may include, for example, an air flap 172 for control of introduction of outside air, a temperature door 174 for control of the temperature of air discharged into the indoor space, and an outside air port door 175 for control of introduction of outside air into the indoor space through the outside air port 20. Each of the blowing device and the opening/closing device may consume power to perform the operation thereof.

Furthermore, the fluid transfer device 100 may include an electric heating device for increase in temperature of air or coolant. The electric heating device to which the controller 300 is operatively connected may include a heater 161 for heating of air discharged to the indoor space in the vehicle. In the instant case, the heater 161 may be implemented as, for example, a positive temperature coefficient (PTC) heater. Furthermore, the electric heating device may also include the heater 162 configured to heat the coolant to increase the temperature of the battery 110b, as described above.

According to the fluid transfer device 100 structured as described above, vehicle thermal management may be performed in various ways. Various thermal management scenarios may be derived in accordance with the state of the indoor space in the vehicle, the state of the outdoor space, the states of the vehicle components 110a and 110b, and the like. To perform thermal management optimized for each of the various thermal management scenarios, it is necessary to precisely determine the air flow rate utilized for performing thermal management.

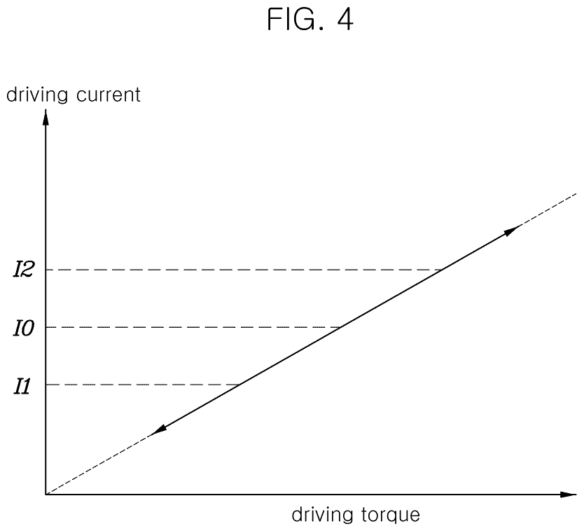

Therefore, the exemplary embodiment of the present disclosure proposes technology for estimating the air flow rate through an estimation model, rather than determining the air flow rate based on a map, improving the precision of determination of the air flow rate under various outside air conditions and thus improving the optimality of thermal management control. In the following description, the air flow rate may refer to, for example, a mass flow rate, which is the mass of air per unit time. A detailed control method based on the air flow rate will be described below with reference to FIG. 3 and FIG. 4.

FIG. 3 is a diagram for explaining the configuration and operation of the controller according to an exemplary embodiment of the present disclosure, and FIG. 4 is a diagram for explaining an outside wind model according to an exemplary embodiment of the present disclosure.

First, referring to FIG. 3, the controller 300 according to the exemplary embodiment of the present disclosure may include a current model 301, an air flow rate model 302, an outside wind model 303, a comparator 304, and a control command generator 305. Although FIG. 3 illustrates only the components related to the description of the exemplary embodiment of the present disclosure, the controller 300 may actually include a greater or smaller number of components than those illustrated in FIG. 3. Depending on embodiments, the controller 300 may be implemented as a single control unit or may be implemented as a combination of a plurality of control units configured to perform different functions.

In more detail, the current model 301 may be set in advance based on a calm wind state in which the outside wind speed is less than or equal to a predetermined reference wind speed. The controller 300 may input outside air pressure, outside air temperature, a vehicle speed, the degree of opening of the inlet 10, and an operation amount of the blowing device 171 to the current model 301 to obtain the estimated driving current value of the blowing device 171.

Such a current model 301 may be generated through learning. In more detail, the current model 301 may be trained based on the degree of opening of the inlet 10, the operation amount of the blowing device 171, and the driving current measurement value of the blowing device 171 for each vehicle speed in the above-described calm wind state.

That is, the current model 301 may be trained to represent a correspondence relationship between the degree of opening of the inlet 10, the operation amount of the blowing device 171, the vehicle speed, and the driving current measurement value of the blowing device 171 in the calm wind state. Accordingly, the driving current of the blowing device 171 may not only be measured through a sensor, but also be estimated through the current model 301.

The air flow rate model 302 may be set in advance based on an outside wind state in which the outside wind speed exceeds the predetermined reference wind speed. The controller 300 may input the degree of opening of the inlet 10, the operation amount of the blowing device 171, the driving current measurement value of the blowing device 171, the vehicle speed, and the outside wind speed to the air flow rate model 302 to obtain the estimated air flow rate value of the inlet 10.

Such an air flow rate model 302 may also be generated through learning. In more detail, the air flow rate model 302 may be trained based on the degree of opening of the inlet 10, the operation amount of the blowing device 171, the driving current measurement value of the blowing device 171, the vehicle speed, and the air flow rate measurement value of the inlet 10 for each outside wind speed measurement value in the above-described outside wind state.

That is, the air flow rate model 302 may be trained to represent a correspondence relationship between the degree of opening of the inlet 10, the operation amount of the blowing device 171, the driving current measurement value of the blowing device 171, the vehicle speed, the outside wind speed measurement value, and the air flow rate measurement value in the outside wind state. Accordingly, the flow rate of outside air introduced through the inlet 10 may not only be measured through a sensor, but also be estimated through the air flow rate model 302.

In the current model 301 and the air flow rate model 302, the reference wind speed is a criterion based on which a determination as to whether there is an influence of the outside wind speed is made. For example, the reference wind speed may be zero or may include a value close to zero.

Furthermore, the outside air pressure and the outside air temperature are used to determine outside air density. Instead of the outside air pressure and the outside air temperature, the outside air density itself, obtained based on the outside air pressure and the outside air temperature, may be an input value of the current model 301.

Furthermore, the degree of opening of the inlet 10 may refer to, for example, an area into which outside air is introduced, and may be varied depending on control of the degree of opening by the inlet opening/closing device 172. However, the degree of opening of the inlet 10 may include a fixed value. In the instant case, the degree of opening of the inlet 10 may be set in advance in the current model 301, rather than being input to the current model 301.

Furthermore, the operation amount of the blowing device 171 may refer to, for example, the rotation speed of the blowing device 171, and may be input in a form of a duty of the blowing device 171.

The current model 301 and the air flow rate model 302 may be trained using a nonlinear regression model, an algorithm such as machine learning, statistical distribution analysis, calibration, etc. Such training may be performed by the controller 300. Alternatively, the current model 301 and the air flow rate model 302 may be trained outside, and may then be stored in the controller 300.

The controller 300 may input the estimated outside wind speed value, obtained based on the outside wind model 303 preset for a relationship between the driving current of the blowing device 171 and the outside wind speed, to the air flow rate model 302 as the outside wind speed to obtain the estimated air flow rate value. The outside wind model 303 will now be described with reference to FIG. 4.

FIG. 4 shows a graph including two axes respectively representing the driving torque of the blowing device 171 and the driving current of the blowing device 171. As shown in the graph, the driving torque and the driving current of the blowing device 171 are proportional to each other, and accordingly, as the driving torque of the blowing device 171 increases, the driving current thereof also increases.

The driving torque of the blowing device 171 may be varied depending on outside air conditions. In more detail, the driving torque of the blowing device 171 may be influenced by the outside wind speed (including direction and magnitude) based on the inlet 10. Assuming that the inlet 10 is provided in the front side of the vehicle, if the outside air flows in the same direction as the travel direction of the vehicle (i.e., tailwind), it is difficult to introduce outside air into the inlet 10, and thus a larger amount of driving torque is required to introduce outside air with larger force. On the other hand, if the outside air flows in a direction opposite to the travel direction of the vehicle (i.e., headwind), the outside air is easily introduced into the inlet 10. Thus, because it is possible to introduce the outside air with smaller force, the driving torque may be lowered. Furthermore, the present flow of outside air may be generated not only by the outside wind direction itself but also by the influence of the behavior of the vehicle. For example, when the vehicle travels forward, the outside air may be relatively easily introduced into the inlet 10, like the headwind situation, and accordingly, a relatively small amount of driving torque may be required. Furthermore, the greater the outside wind speed, the greater the influence of the outside air.

Thus, the controller 300 may obtain the estimated outside wind speed value through the driving current of the blowing device 171 using the outside wind model 303 set to represent a correspondence relationship between the outside wind speed and the driving current.

In more detail, the outside wind model 303 may be set so that the sign of the estimated outside wind speed value is varied depending on a magnitude relationship between the driving current measurement value of the blowing device 171 and reference current I0 corresponding to the calm wind state. For example, if the driving current measurement value includes a value I1 less than the reference current I0 due to headwind, the estimated outside wind speed value may include a positive (+) sign, and if the driving current measurement value includes a value I2 greater than the reference current I0 due to tailwind, the estimated outside wind speed value may include a negative (−) sign. The signs of the above two cases may be varied depending on the implementation example of the outside wind model 303. In any implementation example of the outside wind model 303, the signs of the above two cases are opposite each other.

Furthermore, the outside wind model 303 may be set so that the magnitude of the estimated outside wind speed value is varied depending on a difference between the driving current measurement value of the blowing device 171 and the reference current I0 corresponding to the calm wind state. For example, the estimated outside wind speed value may be proportional to a difference (absolute value) between the driving current measurement value and the reference current I0.

The outside wind model 303 may be set through learning. In the instant case, the air flow rate model 302 may be used. In more detail, the outside wind model 303 may be trained so that the estimated air flow rate value obtained by inputting the estimated outside wind speed value to the air flow rate model 302 coincides with the air flow rate measurement value of the inlet 10.

Similar to the current model 301 and the air flow rate model 302, the outside wind model 303 may also be trained by the controller 300. However, the outside wind model 303 may be trained outside, and may then be stored in the controller 300.

The values input to the current model 301, the air flow rate model 302, and the outside wind model 303 described above may be obtained through various sensors. Since these sensors are well-known in the art, a detailed description thereof will be omitted.

The overall vehicle control process by the controller 300 will now be described with reference to FIG. 3. First, the controller 300 may obtain the estimated driving current value of the blowing device 171 through the current model 301, and may compare the estimated driving current value with the driving current measurement value through the comparator 304.

As a result of the comparison, inconsistency between the estimated driving current value and the driving current measurement value means that there is an error in the driving current value estimated based on the calm wind state, and also means that there is a need to consider outside air conditions. Thus, if the estimated driving current value and the driving current measurement value do not coincide with each other, the controller 300 may obtain the estimated outside wind speed value through the outside wind model 303, and may input the obtained estimated outside wind speed value to the air flow rate model 302 to obtain the estimated air flow rate value of the blowing device 171 in which the outside air conditions are reflected.

Thereafter, the controller 300 may be configured to generate control commands based on the estimated air flow rate value through the control command generator 305, and may transmit the control commands to respective control targets. In the instant case, the control commands may include, for example, a command for control of the degree of opening of the inlet 10 by the inlet opening/closing device 172, a command for control of the operation amount of the blowing device 171, a command for control of the degree of opening of the outside air port 20 by the outside air port opening/closing device 175, and a command for control of the driving force of the driving unit 200.

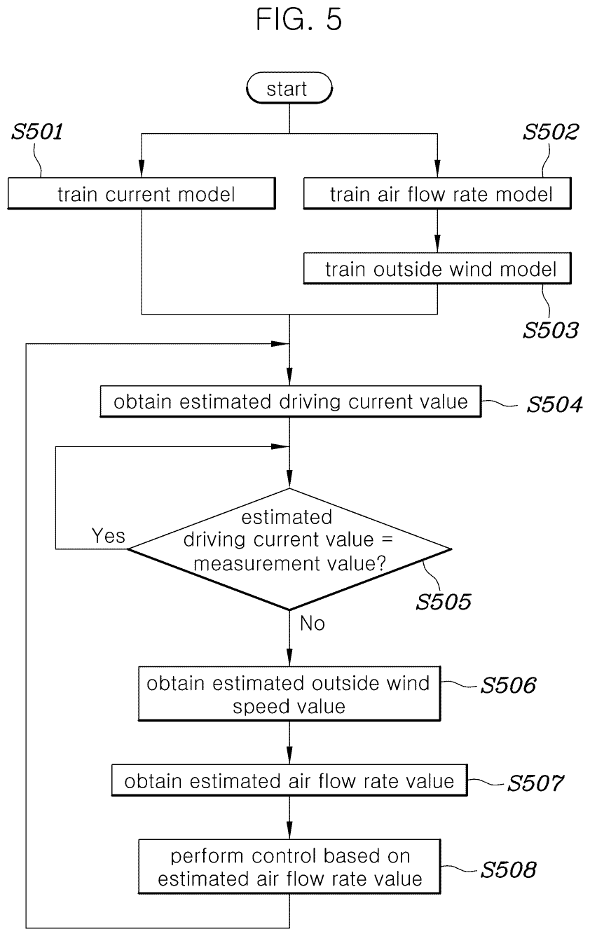

Hereinafter, the control process of the above-described vehicle control system will be described with reference to FIG. 5.

FIG. 5 is a flowchart for explaining a vehicle control method according to an exemplary embodiment of the present disclosure.

Referring to FIG. 5, the current model 301 and the air flow rate model 302 may be first trained (S501 and S502), and the outside wind model 303 may be trained based on the trained air flow rate model 302 (S503).

Thereafter, the controller 300 obtains an estimated driving current value of the blowing device 171 based on the trained current model 301 (S504). Upon determining that the estimated driving current value obtained through the current model 301 does not coincide with a driving current measurement value obtained through a current sensor (No in S505), the controller 300 obtains an estimated outside wind speed value based on the outside wind model 303 (S506).

The obtained estimated outside wind speed value is input to the air flow rate model 302, and accordingly, the controller 300 obtains an estimated air flow rate value of the inlet 10 (S507), and generates a control command based on the estimated air flow rate value to control the fluid transfer device 100 and the driving unit 200 (S508).

The specific content described above with reference to FIG. 1, FIG. 2, FIG. 3, and FIG. 4 may be identically applied to the above processes (S501 to S508).

According to the above-described embodiments of the present disclosure, the precision of determination of the flow rate of air introduced into the vehicle under various outside air conditions may be improved.

Furthermore, since the vehicle is controlled based on the air flow rate determined with high precision, the vehicle may be optimally controlled under each control condition.

As is apparent from the above description, according to various embodiments of the present disclosure, it may be possible to improve the precision of determination of the flow rate of air introduced into a vehicle under various outside air conditions.

Furthermore, since the vehicle is controlled based on the air flow rate determined with improved precision, it may be possible to perform optimal vehicle control under each control condition.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A system for controlling a vehicle based on an air flow rate, the system comprising:
a fluid transfer device including an inlet receiving an outside air introduced thereinto from an outside of the vehicle and a blowing device configured to adjust a flow rate of the outside air introduced into the inlet; and
a controller operatively connected to the fluid transfer device and configured to control introduction of the outside air through the fluid transfer device based on an estimated driving current value of the blowing device, obtained based on a current model preset based on a calm wind state in which an outside wind speed is less than or equal to a predetermined reference wind speed, and an estimated air flow rate value of the inlet, obtained based on an air flow rate model preset based on an outside wind state in which the outside wind speed exceeds the predetermined reference wind speed.

2. The system of claim 1, wherein the controller is further configured to input a degree of opening of the inlet, an operation amount of the blowing device, and a vehicle speed to the current model to obtain the estimated driving current value of the blowing device.

3. The system of claim 2, wherein the controller is further configured to additionally input a pressure and a temperature of the outside air to the current model to obtain the estimated driving current value of the blowing device.

4. The system of claim 1, wherein the current model is trained based on a degree of opening of the inlet, an operation amount of the blowing device, and a driving current measurement value of the blowing device for each vehicle speed in the calm wind state.

5. The system of claim 1, wherein the controller is further configured to input a degree of opening of the inlet, an operation amount of the blowing device, a driving current measurement value of the blowing device, a vehicle speed, and the outside wind speed to the air flow rate model to obtain the estimated air flow rate value of the inlet.

6. The system of claim 5, wherein the outside wind speed input to the air flow rate model is an estimated outside wind speed value obtained based on an outside wind model preset for a relationship between a driving current of the blowing device and the outside wind speed.

7. The system of claim 6, wherein the outside wind model is trained so that the estimated air flow rate value of the inlet obtained by inputting the estimated outside wind speed value to the air flow rate model coincides with an air flow rate measurement value of the inlet.

8. The system of claim 6, wherein the outside wind model is set so that a sign of the estimated outside wind speed value is varied depending on a magnitude relationship between the driving current measurement value of the blowing device and a reference current corresponding to the calm wind state.

9. The system of claim 6, wherein the outside wind model is set so that a magnitude of the estimated outside wind speed value is varied depending on a difference between the driving current measurement value of the blowing device and a reference current corresponding to the calm wind state.

10. The system of claim 1, wherein the air flow rate model is trained based on a degree of opening of the inlet, an operation amount of the blowing device, a driving current measurement value of the blowing device, a vehicle speed, and an air flow rate measurement value of the inlet for each outside wind speed measurement value in the outside wind state.

11. The system of claim 1, wherein, in response that the estimated driving current value of the blowing device obtained based on the current model is different from a driving current measurement value of the blowing device, the controller is further configured to control the introduction of the outside air through the fluid transfer device based on the estimated air flow rate value of the inlet obtained based on the air flow rate model.

12. The system of claim 1, wherein the controller is further configured to control an operation amount of the blowing device to control the introduction of the outside air.

13. The system of claim 1,
wherein the fluid transfer device further includes an inlet opening/closing device operatively connected to the controller and configured to adjust a degree of opening of the inlet, and
wherein the controller is further configured to control the degree of opening of the inlet through the inlet opening/closing device to control the introduction of the outside air.

14. The system of claim 1, wherein the fluid transfer device further includes:
an outside air port allowing the outside air introduced through the inlet to flow into an indoor space in the vehicle therethrough; and
an outside air port opening/closing device operatively connected to the controller and configured to adjust a degree of opening of the outside air port, and
wherein the controller is further configured to control the degree of opening of the outside air port through the outside air port opening/closing device to control the introduction of the outside air.

15. The system of claim 1, further including a driving unit operatively connected to the controller and configured to supply driving force to the vehicle through at least one of an engine or a motor,
wherein the controller is further configured to determine air resistance for the vehicle based on the estimated air flow rate value, and to control the driving force through the driving unit based on the determined air resistance.

16. A method of controlling, based on an air flow rate, a vehicle including a fluid transfer device including an inlet receiving an outside air introduced thereinto from an outside of the vehicle and a blowing device configured to adjust a flow rate of the outside air introduced into the inlet, the method comprising:
obtaining, by a controller, an estimated driving current value of the blowing device based on a current model preset based on a calm wind state in which an outside wind speed is less than or equal to a predetermined reference wind speed;
obtaining, by the controller, an estimated air flow rate value of the inlet based on an air flow rate model preset based on an outside wind state in which the outside wind speed exceeds the predetermined reference wind speed; and
controlling, by the controller operatively connected to the fluid transfer device, introduction of the outside air through the fluid transfer device based on the estimated driving current value of the blowing device and the estimated air flow rate value of the inlet.

17. The method of claim 16,
wherein the obtaining of the estimated driving current value includes inputting a degree of opening of the inlet, an operation amount of the blowing device, and a vehicle speed to the current model to obtain the estimated driving current value of the blowing device, and
wherein the obtaining of the estimated air flow rate value includes inputting the degree of opening of the inlet, the operation amount of the blowing device, a driving current measurement value of the blowing device, the vehicle speed, and the outside wind speed to the air flow rate model to obtain the estimated air flow rate value of the inlet.

18. The method of claim 17, wherein the outside wind speed input to the air flow rate model is an estimated outside wind speed value obtained based on an outside wind model preset for a relationship between a driving current of the blowing device and the outside wind speed.

19. The method of claim 16,
wherein the current model is trained based on a degree of opening of the inlet, an operation amount of the blowing device, a vehicle speed, and a driving current measurement value of the blowing device in the calm wind state, and
wherein the air flow rate model is trained based on the degree of opening of the inlet, the operation amount of the blowing device, the driving current measurement value of the blowing device, the vehicle speed, an outside wind speed measurement value, and an air flow rate measurement value of the inlet in the outside wind state.

20. The method of claim 16, wherein the controlling of the introduction of the outside air includes controlling the introduction of the outside air through the fluid transfer device based on the estimated air flow rate value of the inlet obtained based on the air flow rate model in response that the estimated driving current value of the blowing device obtained based on the current model is different from a driving current measurement value of the blowing device.
